(19) United States
(12) Patent Application Publication
(10) Pub. No.: US 2017/0226346 A1
(43) Pub. Date: Aug. 10, 2017

(54) ANTI-SOILING COMPOSITIONS CONTAINING NANOPARTICLES AND POLYMERS WITH CARBOXYLIC ACID GROUPS OR SALTS THEREOF

(71) Applicant: 3M INNOVATIVE PROPERTIES COMPANY, SAINT PAUL, MN (US)

(72) Inventors: KATHERINE A. BROWN, LAKE ELMO, MN (US); TIMOTHY N. NARUM, LAKE ELMO, MN (US); MAHFUZA B. ALI, MENDOTA HEIGHTS, MN (US)

(73) Assignee: 3M INNOVATIVE PROPERTIES COMPANY, SAINT PAUL, MN (US)

(21) Appl. No.: 15/502,919

(22) PCT Filed: Aug. 6, 2015
(86) PCT No.: PCT/US15/44004

§ 371 Date: Feb. 9, 2017

Related U.S. Application Data
(60) Provisional application No. 62/036,720, filed on Aug. 13, 2014.

(51) Int. Cl. C09D 5/00; C09D 133/14; C03C 17/32; C09D 133/24; C09D 133/02; C03C 17/00; C09D 7/12; C09D 135/02

(52) U.S. Cl. CPC C09D 5/00; C09D 7/1291; C09D 7/1266; C09D 133/14; C09D 135/02; C09D 133/24; C09D 133/02; C09D 7/1216; C03C 17/007; C03C 17/32; C08K 7/18

(57) ABSTRACT

A coating composition is provided comprising nanoparticles and certain polymers comprising carboxylic acid groups or salts thereof. When applied to articles, the coating is resistant to soiling by both dry dust and wet soil. Coated articles and methods of applying coatings are also described herein.

A coating composition is provided comprising nanoparticles and certain polymers comprising carboxylic acid groups or salts thereof. When applied to articles, the coating is resistant to soiling by both dry dust and wet soil. Coated articles and methods of applying coatings are also described herein.

### BACKGROUND

Renewable energy is energy derived from natural resources that can be replenished, such as sunlight, wind, rain, tides, and geothermal heat. The demand for renewable energy has grown substantially with advances in technology and increases in global population. Although fossil fuels provide for the vast majority of energy consumption today, these fuels are non-renewable. The global dependence on these fossil fuels has not only raised concerns about their depletion but also environmental concerns associated with emissions that result from burning these fuels. As a result of these concerns, countries worldwide have been establishing initiatives to develop both large-scale and small-scale renewable energy resources. One of the promising energy resources today is sunlight. Globally, millions of households currently obtain power from solar energy generation. The rising demand for solar power has been accompanied by a rising demand for devices and materials capable of fulfilling the requirements for these applications.

The performance of glass surfaces of optical components (“optical surfaces”), such as those that transmit, absorb or reflect light when in use, is reduced if/when the optical surface becomes soiled. Soiling generally reduces light transmittance, increases absorbance, and/or increases light-scattering. This is particularly problematic for optical surfaces that are subjected to constant outdoor exposure. Examples of such optical surfaces include, but are not limited to, the glass sun-facing surfaces of photovoltaic (PV) modules, the glass surface of mirrors employed in solar energy generation systems wherein the function of the mirror is to direct incident sunlight to a collecting device or PV module with or without simultaneous concentration of the light, glass lenses (e.g., Fresnel lenses) and glass architectural glazing (e.g., windows). In some applications, glass substrates include a layer of glass and a layer of metal. Mirrors with high specular or total hemispherical reflectance may be used in certain solar energy generation systems, and such mirrors are particularly susceptible to degradation of performance by even small amounts of soiling.

Many solar power systems are installed in dry locations with periods of low relative humidity where dust accumulation is a particular problem. The present inventors have previously developed coating compositions and application methods that provide resistance to dust accumulation (for example, PCT Application No. PCT/US2013/049300 and PCT Application No. PCT/US2015/014161). However, in other locations where PV arrays or CSP systems are installed and even in some desert locations there are other soiling mechanisms that are due to or are influenced by the presence of water, for example, soiling from soil-water slurries that form during seasonal wet periods, light rain and/or light or heavy condensation. The compositions disclosed herein provide improved resistance to soiling mechanisms that occur due to the presence of water. While other coating compositions have been developed that will readily shed water, they do not address the problem of dust accumulation and are generally only useful under limited conditions where soiling occurs in the presence of water, for example, they are usually most effective at resisting soiling from soil-water slurries that contain very little soil. There is thus a need for improved coatings that will accomplish both reduction in soiling due to dry dust and a reduction in soiling occurring in the presence of soil and water combinations.

### SUMMARY

The present disclosure may refer to some embodiments as “preferred,” or “more preferred,” or may use other language that denotes that some embodiments may be preferred in certain instances over other embodiments. The disclosure of that type of preferences is intended to serve as guidance to the reader about some embodiments that under certain circumstances may perform better than other embodiments, but is not intend to exclude less preferred embodiments from the scope of the present invention.

The inventors of the present disclosure have recognized that in many outdoor locations soiling results from a combination of events including the accumulation of air-borne dust and soiling that results from multiple mechanisms wherein water and soil are present and combined in various amounts, and combinations of these.

The inventors of the present application recognized that the performance of optical surfaces is reduced if the surface is soiled, whether due to accumulation of air-borne dust or soiling that occurs in the presence of water and soil or some combination thereof. The inventors of the present disclosure have discovered additional coating compositions and application methods that reduce the amount of soiling that accumulates on an optical surface over a period of time.

Soiling can result in decreased performance and/or efficiency of a solar energy generating device. Decreased performance and/or efficiency can result in decreased energy generation. The inventors of the present disclosure have discovered coating compositions and application methods that maintain or increase the amount of energy generated by solar devices, when such devices are installed outdoors, and for a useful period of time.

The inventors of the present disclosure have recognized that in many instances the owners or operators of solar energy generating devices do not wish to remove soil from optical surfaces, due to the time and expense involved as well as scarcity of water for cleaning in some locations. However, they do welcome adventitious cleaning that may be accomplished by naturally occurring events, such as a light rainfall. In addition to improved performance of solar energy generating devices, owners or operators may also prefer a device that appears clean upon visual inspection.

The inventors of the present disclosure recognized that optical components may be installed in environmentally sensitive locations, be operated by persons who are particularly interested in protecting the environment, and/or need to meet various environmental, health, and safety requirements. Environmental, health, and safety requirements are becoming increasing difficult to meet, and there is a need for coating compositions that contain little or, even no solvents, surfactants, wetting agents, leveling agents, or other additives that are typically used to achieve advantageous coating properties, such as uniform spreading. In addition, the coating compositions must provide a coated surface that can resist the accumulation of soil for a useful period of time and withstand the effects of any cleaning that may occur, whether intentional (by the system operators) or adventitious (e.g., rain).

The inventors of the present disclosure recognized the following additional desired characteristics for coating compositions and methods. It is preferable that the coating be durably adhered to the optical surface. The coating method is preferably suitable for use in a variety of outdoor situations and should not require large, heavy or sophisticated equipment, process controls or highly skilled workers. Equipment or materials that are adjacent to optical surfaces, such as, for example, frames, support structures, racking, structural elements, sealants, caulking, painted surfaces, signing, and the like, must not be damaged or degraded by the coating composition and application method, as might happen if the coating composition was inadvertently applied to an adjacent component and not removed. For example, materials that cause oxidation of organic materials, including photo-activated oxidative materials and thermal or photoactivated oxidative catalysts, should be excluded if possible. In desert locations, where many PV arrays or CSP systems are installed, water is scarce and the amount of water required for the coating composition and/or application method should be minimal.

The inventors of the present disclosure discovered coating compositions and methods of application to simultaneously accomplish many or all of the goals described above. In at least some embodiments, the performance and appearance of the coated article may depend on one or more of coating composition and the coating method.

### DETAILED DESCRIPTION

Many solar energy generation devices are installed in locations where solar irradiance is high, due to combination of latitude and climate conditions (e.g., a climate where there is generally very little cloud cover). Further, for utility-scale solar energy installations, a large amount of land is needed. Thus, many solar energy systems are advantageously installed in hot, dry climates and, in particular, in deserts. The amount of energy produced by a solar energy system decreases as soil accumulates, resulting in losses of from about 5% to about 40% relative to the originally installed, clean solar energy system. There is also a need to prevent soil accumulation on the windows of buildings. It is time-consuming and expensive to clean windows, and in some locations water for this purpose may be scarce.

Desert locations may have periods of very low relative humidity, as low as 20% or even as low as 5% relative humidity, especially during the heat of the day, and the accumulation of dry dust is especially a problem under these conditions. In particular, glass surfaces of optical components installed outdoors in dry locations accumulate dry dust, particularly during periods of low relative humidity. This dust or soil can significantly reduce the performance of the optical component. The composition of air-borne dust, the mechanisms by which it is attracted to and adhered to a glass surface, and the effect of this dust on performance seem to be significantly different than other types of soiling, such as soiling that occurs in the presence of water. Most air-borne dust particles are very small, typically less than 5 microns in diameter (or, if non-spherical, its largest dimension is less than 5 microns) and often less than 1 micron in diameter. Without wishing to be bound by theory, the inventors believe that the adhesion of such small particles to a surface depends on topographical features, especially roughness, on the surface. This may be true if those features are of dimensions that are of similar dimensions as those of the dust particle, for example, from about 1% to about 100% of the size of the dust particle, such that adhesion, such as might be due to van der Waals forces, is reduced due to the reduced contact area between the particle and the rough surface.

However, most desert locations also experience periods of higher relative humidity and daily temperature fluctuations that may lead to condensation of water on solar optical surfaces. Additionally, most desert locations typically experience at least small amounts of rainfall during at least a portion of a typical annual cycle; in fact, it is only in the driest places on earth, such as in some portions of the Atacama Desert in Chile, where rainfall has never been recorded. Thus in most locations, including most desert locations, there is also a soiling component that is water-mediated, due to seasonal wet periods, light rain and/or light or heavy condensation.

There are several aspects of water-mediated soiling. One aspect of water-mediated soiling is that soil suspensions or slurries of water and soil may be produced, either by water falling or condensing onto a surface that already has some air-borne or other soil on it, or by soil being captured by water droplets, either as they fall through dusty air and fall onto the surface, or by soil being captured by water droplets as they reside on a surface and air-borne dust passes by and is captured. There are other variations on these combinations, but the end result is a slurry of various proportions of water to soil. These water-soil slurries may move over the surface of the optical component, whether at initial impact or during flow due to gravity. Without wishing to be bound by theory, the inventors believe that as these water-soil slurries move over the surface, the particles will experience shear forces, and shear-thickening may occur, leading to regions of concentrated or compacted soil. Alternatively, the water may evaporate from a water-soil slurry, again leaving portions of concentrated or compacted soil. Concentrated or compacted soil produced by these mechanisms may be surprisingly difficult to remove; immediately after formation, even without drying, it may be difficult or impossible to remove by gentle methods such as rinsing with clean water or by the action of subsequent rainfall. Mechanical action (scrubbing) is not desirable but it may be required to remove concentrated or compacted soil. Although the reasons for the apparent “structural integrity” of concentrated or compacted soil are not well understood, it is quite common to find difficult-to-remove soil, such as water spots, streaks, or even smooth layers of soil on many outdoor surfaces that have been exposed to some combination of soil and water.

Furthermore, the formation of compacted or concentrated soil is more likely to occur as the ratio of soil to water increases. That is, as more soil is present (as compared to the amount of water) in a soil-water slurry, compacted or concentrated soil is more likely to form, and when less soil is present (as compared to the amount of water) in a soil-water slurry, compacted or concentrated soil is less likely to form. It is occasionally observed that in areas with frequent, typically daily heavy rainfall, and where as a result there are very low ratios of soil to water in slurries that may form on a surface, soiling due to dry dust or water-soil slurries is not a significant problem. However, in most locations worldwide, there will be a portion of time during the annual cycle when a soil-water slurry is formed in a soil-to-water ratio that results in compacted or concentrated soil on a surface, which may then be difficult to remove, except with mechanical action. Additionally, since it is advantageous to achieve lower soil-water ratios whenever water is present (to minimize the formation of concentrated or compacted soil), it is desirable to minimize the accumulation of dry dust during periods of little or no water, so as to both reduce losses due to soiling during dry seasons and simultaneously reduce the ratio of soil-to-water for the amount of water that may be present when, for example, a light rain does occur.

Those skilled in the art will realize that that are certain circumstances among those described above, when it will be impossible to prevent the formation of water-soil slurries on a surface and also impossible to prevent some of these slurries from drying. So, while it is advantageous to minimize the accumulation of dry dust by applying a coating to a surface, it is also necessary for that coating to additionally provide an improved means for easy removal of concentrated or compacted soil that may result from the water-soil slurries, such as removal of concentrated or compacted soil by rinsing without mechanical action or by gentle rainfall.

Coatings that function to reduce the accumulation of dry dust, reduce the formation of compacted or concentrated soil from soil-water slurries and/or enhance the removal of concentrated or compacted soil in the presence of water without the use of mechanical action, including adventitious cleaning by light rain or condensation, are considered to have anti-soiling properties. In different locations worldwide, as climate and weather patterns vary, it may be preferable to use coatings that reduce the accumulation of dry dust, reduce the formation of compacted or concentrated soil from soil-water slurries and/or enhance the removal of concentrated or compacted soil in the presence of water without the use of mechanical action in different proportions. That is, in one location a useful coating may be optimized to provide very high reduction of dry dust accumulation and medium removal of concentrated or compacted soil in the presence of water, while in another location a useful coating may provide medium reduction of dry dust accumulation and high removal of concentrated or compacted soil in the presence of water. Various combinations of coating attributes may be useful in various locations and are within the scope of this invention.

Many optical surfaces, in solar energy generating systems and on windows, have been designed to have specific properties, which may be related to performance (transmission, absorption, reflectance, haze, scattering/diffusion, etc.) or aesthetics (color, reflectance, etc). Often, these properties are provided in the glass as part of a manufacturing step, prior to installation or incorporation into the final system or structure. Preferably, coatings applied to an installed system or structure do not change these performance or aesthetic properties. Consequently, it is preferable in at least some embodiments, that the final, dry coating be very thin (e.g., less than about 50 nm). For example, a coating of 125 nm may be transparent and provide anti-reflective behavior to a glass surface, but this reduction in reflectivity may be undesirable in some embodiments if a certain amount of reflectance was designed into the glass for its intended function or appearance. Further, at low viewing angles, a coating of 125 nm will have a longer effective path length for incident light and give the appearance of being purple or blue. Coatings of 100 nm, or even 75 nm, can provide visual effects, particularly when viewed at low angles. A coating that is less than about 50 nm thick will typically produce no such visual effects, that is, it will be invisible. Nonetheless, the skilled artisan would understand that the desired characteristics of an anti-soiling coating will depend on the particular use and that the thickness of a coating according to the present disclosure can be adapted as needed. Thus, thicknesses greater than 50 nm are still within the scope of this disclosure in cases where the circumstances permit such thickness. As used herein, “invisible” means that the coating will not cause any significant optical effect that may be detected by the average human eye. In cases where certain surface roughness is desired, the inventors believe that the average coating thickness must be no more than about twice as thick as the average diameter of the large nanoparticles in the coating composition, preferably no more than 1.5 times as thick, more preferably no more than 1 times as thick, even more preferably no more than 0.75 times as thick, in order to achieve the desired surface roughness.

### Exemplary Embodiments

The present disclosure provides a liquid coating composition comprising an aqueous dispersion of a first set of non-oxidizing nanoparticles having an average diameter of 20 to 120 nm (hereafter referred to as large nanoparticles), optionally a second set of non-oxidizing nanoparticles having average diameter of less than 20 nm (hereafter referred to as small nanoparticles), a polymer wherein at least 90% of monomer units comprise at least one carboxylate group or the conjugate acid thereof, optionally a metallic cation with a positive charge of at least +2, and optionally a non-polymeric acid. In certain embodiments, the polymeric acid has a pKₐ less than or equal to 3.5. In preferred embodiments, the first set and second set of non-oxidizing nanoparticles are silica nanoparticles.

Preferably, at least 95% of the monomer units in the polymer comprise at least one carboxylate group or the conjugate acid thereof. In other embodiments, at least 99% of the monomer units in the polymer comprise at least one carboxylate group or the conjugate acid thereof.

The large nanoparticles have an average diameter of 20 to 120 nm, preferably 20 to 75 nm, or in another embodiment preferably 40 to 120 nm, or in another embodiment preferably 40 to 75 nm. Without wishing to be bound by theory, the inventors believe that the large nanoparticles create a dried coating with a particular surface roughness. The optional small nanoparticles have an average diameter of less than 20 nm, preferably less than 10 nm. Because of their small diameter, the small nanoparticles have a very large amount of surface area and the atoms at the surface are very reactive. Without wishing to be bound by theory, the inventors believe that the small nanoparticles are sufficiently reactive to form chemical bonds to the substrate and to other nanoparticles (both large and small). In other embodiments, the liquid coating composition optionally contains a bimodal distribution of nanoparticles, with the small nanoparticles selected to provide desirable reactivity and the large nanoparticles selected to provide desirable surface roughness.

Large nanoparticles are included in the coating composition in amounts that do not deleteriously decrease the coatability of the composition on selected substrates and do not produce visible optical effects. The inventors believe that the large nanoparticles, in combination with the thickness of the dried coating on the substrate, produce a coating surface that has an average surface roughness of from 5 nm to 100 nm over a 5 micron by 5 micron area.

The liquid coating composition may contain from 0.1 to 10% by weight, preferably 0.25 to 10%, more preferably 0.5 to 5% of the first set of nanoparticles (large nanoparticles). The liquid coating composition may contain from 0 to 10% by weight, preferably 0 to 5% of the optional second set of nanoparticles (small nanoparticles). If both the first set and second set of nanoparticles are used, the amount by weight of the first set to the second set may range from a ratio of 0.2:99.8 to 99.8:0.2, preferably a ratio of 1:9 to 9:1.

In certain embodiments, nanoparticles comprising non-oxidizing materials, for example, silica, alumina, other metal oxides or naturally occurring minerals, may be used. Nanoparticles that may function as catalysts or photocatalysts for oxidative degradation are not suitable in the practice of this invention if they cause unacceptable decomposition of the polymer in the coating liquid and/or coated article.

In certain embodiments, at least 90% of the monomer units in the polymer comprise at least one carboxylate group, with counter ions (cations) such as lithium, sodium, or potassium, or the conjugate carboxylic acid (that is, the protonated carboxylate group). As used in the description of the polymers, “90%” means 90% by weight of the total weight of the polymer. Preferably, 95% of the monomer units in the polymer comprise at least one carboxylate group or the conjugate acid thereof. In other embodiments, at least 99% of the monomer units in the polymer comprise at least one carboxylate group or the conjugate acid thereof.

When the liquid coating composition contains a non-polymeric acid with pKₐ less than or equal to 3.5, some or all of the carboxylate groups on the polymer are likely to be protonated, that is, to be found as the conjugate acid of the corresponding anion, with proportions depending on the amounts of the various carboxylate groups and the acid. Preferably the polymer backbone comprises carbon and hydrogen. Examples of suitable polymers include poly(acrylic acid, as a carboxylate salt), poly(acrylic acid, sodium salt), poly(acrylic acid, lithium salt), poly(acrylic acid, potassium salt), poly(acrylic acid), any combination of conjugate base, counterion and acidic units of poly(acrylic acid), poly(itaconic acid, as a carboxylate salt), poly(itaconic acid, lithium salt), poly(itaconic acid, sodium salt), poly(itaconic acid, potassium salt), poly(itaconic acid), any combination of conjugate base, counterion and acidic units of poly(itaconic acid), copolymers of acrylic acid and itaconic acid in proportions ranging from about 99% acrylic acid and 1% itaconic acid to about 1% acrylic acid and 99% itaconic acid and the lithium, sodium and potassium salts of their conjugate bases in all combinations, poly(beta-carboxyethyl acrylate acid, as a carboxylate salt), poly(beta-carboxyethyl acrylate acid, lithium salt), poly(beta-carboxyethyl acrylate acid, sodium salt), poly(beta-carboxyethyl acrylate acid, potassium salt), poly(beta-carboxyethyl acrylate acid), any combination of conjugate base, counterion and acidic units of poly(beta-carboxyethyl acrylate acid), copolymers of acrylic acid and beta-carboxyethyl acrylate acid in proportions ranging from about 99% acrylic acid and 1% beta-carboxyethyl acrylate acid to about 1% acrylic acid and 99% beta-carboxyethyl acrylate acid and the lithium, sodium and potassium salts of their conjugate bases in all combinations, and other combinations as are apparent to those skilled in the art. In certain embodiments, depending on the pH of the coating liquid, a combination of protonated carboxylic acid groups and anionic carboxylate groups may be present. Other monomers include methacrylic acid and its conjugate bases. A mixture of any of the above polymers may also be used. Any of the above polymer compositions containing up to about 10% of other monomer units, for example, esters of acrylic acid or esters of methacrylic acid, are within the scope of this invention. Preferably, the polymer may contain up to 5% of other monomer units and more preferably, the polymer may contain up to 1% of other monomer units. Surprisingly, in certain embodiments, polymers or copolymers comprising as little as 10% of other monomer units that do not contain a carboxylate group or the conjugate acid thereof, for a comparative example, a polymer containing 10% by weight of beta-methoxyethyl acrylate comonomer, are not effective when incorporated into anti-soiling compositions.

By “monomer unit” we mean one unit in the polymer that was derived from one individual molecule (monomer) that was combined with other individual molecules (monomers) to form the polymer, for example, the polymer unit derived from acrylic acid, as shown:

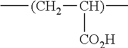

the polymer unit derived from itaconic acid, as shown:

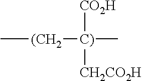

or the polymer unit derived from beta-carboxyethyl acrylate, as shown:

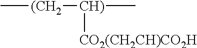

or the conjugate bases of these acids. Those skilled in the art will recognize that it may be possible to utilize different monomers in a polymerization step and to convert them in subsequent chemical steps to polymer units that are within the scope of this invention, for example, to utilize methyl acrylate in a polymerization step and to subsequently hydrolyze some or all of the methyl ester groups in the polymer to carboxylic acid groups. Such embodiments are also within the scope of this disclosure.

Without wishing to be bound by theory, the inventors believe that the polymers described in this disclosure have a particular combination of properties including affinity for water and hardness and/or crystallinity that allows them to function effectively in an anti-soiling coating.

In some embodiments, the polymer may contain no more than 10% of acrylamide units. In other embodiments, the polymer may contain no more than 5% of acrylamide units, and preferably no acrylamide units.

In certain embodiments, the polymer may have a molecular weight of 1000 to 250,000 amu, preferably 1000 to 100,000 amu, or in another embodiment preferably 5000 to 50,000 amu. In certain embodiments, the polydispersity or ratio of number average to weight average molecular weight (Mₙ/M_{w}) may be in the range of 1.0 to 20.

Poly(acrylic acid) in the protonated form and as the lithium and sodium salts, in various molecular weights, may be obtained from numerous suppliers, including Sigma-Aldrich Corporation (St. Louis, Mo.) and Polysciences, Inc. (Warrington, Pa.).

The liquid coating composition may contain from 0.05 to 20% by weight, preferably 0.1 to 10%, more preferably 0.2 to 5% and more preferably still 0.2 to 2% of the polymer wherein at least 90% of the monomer units comprise at least one carboxylate group or the conjugate acid thereof. The amount by weight of nanoparticles (combined total) to polymer may range from a ratio of 20:1 to a ratio of 1:20.

Optionally, the coating composition may contain a non-polymeric acid. In certain embodiments, the non-polymeric acid has a pKₐ (H₂O) of ≦3.5. In one embodiment, the non-polymeric acid has a pKₐ (H₂O)<2.5. In one embodiment, the non-polymeric acid has a pKₐ (H₂O) of less than 1. Useful non-polymeric acids include H₂SO₃, H₃PO₄, CF₃CO₂H, HCl, HBr, HI, HBrO₃, HNO₃, HClO₄, H₂SO₄, CH₃SO₃H, CF₃SO₃H, CH₃SO₂OH, oxalic acid, tartaric acid, and citric acid. Nanoparticle dispersions may be at a basic pH, that is, pH of 7.1 or higher, as supplied by the manufacturer, and it may be useful to reduce the pH of this dispersions using non-polymeric acids of pKₐ (H₂O) of ≦3.5 or it may be useful to use non-polymeric acids with pKₐ (H₂O) of ≧3.5, such as acetic acid. Preferred non-polymeric acids include acetic acid, citric acid, oxalic acid, tartaric acid, HCl, HNO₃, H₂SO₄, and H₃PO₄. The coating composition may contain sufficient non-polymeric acid to provide a pH of less than 5, preferably less than 4.5. In another embodiment, the coating composition may have a pH in the range of 5 to 9, preferably pH in the range of 6 to 8. In certain embodiments, the pKₐ of the polymers of this invention are in the range of about 4.5 to 3.8 (first pKₐ) so the polymer composition and amount of each monomer unit in the polymer relative to the amount of nanoparticle dispersion and optional non-polymeric acid will determine the pH of the coating composition. Nanoparticle coating compositions utilizing some non-polymeric acids are described in detail in PCT Patent Publication No. WO 2009/140482.

Optionally, the coating composition may comprise a metallic cation with a positive charge of at least +2, also referred to as a polycation. This polycation may be able to form ionic bonds with two carboxylate groups on different monomer units on the same polymer chain or with two carboxylate groups on different polymer chains to form ionic crosslinks. Without being bound by theory, the inventors believe that ionic crosslinking may reduce the solubility of the polymer in water or other solvents and may increase the useful lifetime of a coated article when it is subjected to the action of water, for example, during occasional cleaning or maintenance operations or during periods of rain.

In certain embodiments, the coating composition comprises a metallic cation with a positive charge of at least +2. Suitable polycations include those in Groups (columns) 2 through 16 of the Periodic Table of the Elements, including the Lanthanoid and Actinoid series. Many metallic cations are known to those skilled in the art and may provide useful crosslinking, but, in certain embodiments, it may be preferable to avoid the use of metallic polycations that are known to be toxic or harmful to humans, aquatic life and the like, such as, for example, Cr⁺⁶, Cd⁺², Pb⁺² or Pb⁺⁴, polycations that are regulated or restricted in their use, polycations that are scarce or expensive, for example, Pt⁺², and so on. In other embodiments, it may be preferable to avoid the use of metallic polycations that may function as or produce a catalyst or photocatalyst for the degradation of organic materials, including polymers, for example, Ti⁺⁴. Preferred metallic polycations include, for example, Zn⁺², Cu⁺², Fe⁺², Fe⁺³, Al⁺³, Mg⁺², Ca⁺², Ba⁺², Zr⁺⁴, Ce⁺³ and Ce⁺⁴. Water-soluble metallic cations are preferred in some embodiments. More complex molecular polycations, for example, diammonium, triammonium and disulfonium cations, are also suitable for crosslinking the polymers of this disclosure. However, certain ammonium cations may attract and hold soil, and it would be preferable to avoid those cations that do not produce effective anti-soiling coatings.

Metallic cations are typically supplied as salts with counterions, and suitable counterions include hydroxide, the halides, nitrates, sulfate, sulfonates, phosphates, phosphonates, carbonates, carboxylates, alkoxides and the like. As is well known to those skilled in the art, many of these salts may be supplied as so-called hydrates, with one, two or up to 9 or more water molecules, including non-integral amounts of water molecules, associated with the salt, and such materials may be used in the practice of this invention. In some embodiments, a preferred counterion for the metallic cation with charge of at least +2, is the acetate anion. Examples of preferred salts include zinc acetate, zinc acetate dihydrate, copper(II) acetate monohydrate, aluminum acetate (supplied as a soluble form stabilized with boric acid), copper(II)hydroxide, copper(II) chloride dihydrate, copper(II) hydroxide phosphate, copper(II) methoxide, iron(III) chloride hexahydrate, iron(II) acetate, iron(III) nitrate nonahydrate, iron(III) oxalate dihydrate, zinc nitrate hexahydrate, zinc sulfate heptahydrate, zinc sulfate monohydrate, zirconium acetate, zinc carbonate hydroxide monohydrate, zinc chloride, calcium acetate hydride, magnesium acetate tetrahydrate, barium acetate, cerium(III) acetate hydrate, cerium(IV) sulfate and aluminum nitrate nonahydrate. Many other salts are available to those skilled in the art and form part of the scope of this disclosure.

In certain embodiments, when the metal cation is present in the liquid coating composition, the salt of the metallic cation with charge of at least +2 may be included in the composition in an amount from 0 to 5%, preferably 0 to 2% and more preferably 0 to 1% by weight. The ratio by weight of the salt of the metallic cation to the polymer may be in the range of 0 to 2.0, preferably 0 to 1.0. Preferably, materials and amounts of materials are selected so that the polymer remains soluble or dispersed in the coating liquid and the formation of large amounts of solid or precipitant are preferably avoided in certain embodiments.

The coating liquid comprises water as the liquid phase. Preferably, water comprises at least 90% of the liquid used in the preparation of the coating, more preferably at least 95%. The coating liquid contains no more than 25% by weight, preferably no more than 10% by weight and more preferably no more than 5% by weight of organic solvents. In certain embodiments, the liquid coating composition contains no added organic solvents.

Preferably, the coating composition includes at most 2% by weight, preferably at most 0.5% by weight, more preferably at most 0.1% by weight and more preferably still essentially no (based on the total weight of the liquid) of detergents, surfactants, leveling agents, colorants, dyes, perfumes, binders or materials that can act as oxidizers, oxidative catalysts or oxidative photocatalysts. By “essentially no”, we mean no intentionally added amount of material except for traces that may be present unintentionally as impurities. In certain embodiments, it may be preferable to avoid the addition of surfactants or detergents, because use of some of these materials may result in a coating that attracts and/or holds soil, rather than functioning as an anti-soiling coating. That is, surfactants or detergents that may be described elsewhere as useful in compositions intended for use in cleaning (where is it desirable to attract or bond to soil and contaminants in the cleaning process) may be disadvantageous in the coating liquids or coated articles of this invention. Thus, in some embodiments, the coating compositions consist essentially of water, the first and optional second sets of silica nanoparticles described above, the polymers described above, optionally a metallic cation with a positive charge of at least +2, and optionally a non-polymeric acid.

Accordingly, in one embodiment, the antisoiling coating composition comprises an aqueous composition of a first set of silica nanoparticles having an average diameter of 20 to 120 nm, optionally a second set of silica nanoparticles having average diameter of less than 20 nm, a polymer comprising monomer units wherein at least 90% of the monomer units comprise at least one carboxylate group or the conjugate acid thereof, optionally a metallic cation with a positive charge of at least +2, and optionally a non-polymeric acid

The present disclosure further provides a method of providing a coating to a substrate comprising applying the liquid coating composition to the substrate, optionally removing a portion of the liquid coating composition, and removing the volatile components from the liquid coating composition that has been applied to the substrate. The coating method may comprise one or more liquid components and one or more steps, in any combination. PCT Application No. PCT/US2013/049300 describes various embodiments of coating methods whose steps can be used in the application of the coating compositions of the present disclosure. The original claims of PCT Application No. PCT/US2013/049300, as well as its disclosure associated with coating methods are incorporated by reference herein.

Preferably the substrate comprises an inorganic material, more preferable a metal oxide, most preferably silica. A particularly suitable substrate is a silica-containing glass, for example, soda-lime glass, low-iron soda-lime glass, borosilicate glass, and many other silica-containing glasses as are well-known. Alternatively, the substrate may be a polymeric material, such as a film, sheet, molded article or painted article, or the substrate may be a combination of polymeric and inorganic materials.

In another embodiment, the disclosure is directed to a method of forming a coating on a glass substrate, comprising: (i) applying an aqueous coating composition to the glass substrate; wherein the aqueous coating composition comprises an aqueous composition consisting essentially of: water, a first set of non-oxidizing nanoparticles having an average diameter of 20 to 120 nm, optionally a second set of non-oxidizing nanoparticles having average diameter of less than 20 nm, a polymer wherein at least about 90% of the monomer units comprise at least one carboxylate group or the conjugate acid thereof, optionally a metallic cation with a positive charge of at least +2, and optionally a non-polymeric acid.

The present disclosure further provides a coated substrate or article, wherein the coating comprises a dried mixture of non-oxidizing nanoparticles having an average diameter of 20 to 120 nm, optionally non-oxidizing nanoparticles having average diameter of less than 20 nm, a polymer wherein at least 90% of the monomer units comprise at least one carboxylate group or the conjugate acid thereof, optionally a metallic cation with a positive charge of at least +2, and optionally a non-polymeric acid, wherein the components may preferentially be partially bonded together by chemical or ionic bonds. Preferably the dried mixture is partially bonded to the substrate. In certain preferred embodiments, the bond between the substrate and the dried coating is between the components of the composition described in this disclosure and the surface of the substrate, without the need to have additional bonding components. Preferably the dried coating mixture has an average thickness of from about 0.5 nm to about 100 nm, more preferably about 2 nm to about 75 nm average thickness, even more preferably about 5 nm to about 50 nm average thickness. Preferably the coating has an average surface roughness of between about 5 nm and about 100 nm over a 5 microns by 5 microns area. Preferably the dried mixture is at least partially crosslinked.

In yet another embodiment, the coated article comprises a dried coating, wherein the dry coating consists essentially of: a first set of silica nanoparticles having an average diameter of 20 to 120 nm, optionally a second set of silica nanoparticles having average diameter of less than 20 nm, a polymer wherein at least 90% of the monomer units comprise at least one carboxylate group or the conjugate acid thereof, optionally a metallic cation with a positive charge of at least +2, and optionally a non-polymeric acid.

The coated substrate derived from the coating composition may be hydrophilic. The coated substrate may be sufficiently hydrophilic that a water drop applied to the surface immediately spreads on the surface and it may spread so rapidly and over such a large area, that it is difficult or impossible to measure the so-called contact angle. When contact angles are almost zero degrees or immeasurable, the surface is often described as “superhydrophilic.” Superhydrophilic coatings have been previously described. Comparative Examples in this disclosure, for example, CE 101, are superhydrophylic. Superhydrophilic surfaces may resist the accumulation of dry dust. However, the property of superhydrophilicity alone is not sufficient to provide for easy removal of concentrated or compacted soil produced from soil-water slurries.

Without wishing to be bound by theory, the inventors believe that enhancing the retention of a very thin layer of water and/or enhancing the mobility of a very small amount of water on the surface will provide for easier removal of concentrated or compacted soil. The water layer may be only a monolayer or a few monolayers thick and thus very difficult to observe by known analytical techniques. Thus, functional tests of anti-soiling performance are used to determine the effectiveness of coatings. One functional test developed by the inventors is a laboratory test specifically designed to measure the ability of the coating to resist soiling by dry dust, and the details are described below for the performance of the “Dry Dust Test.” The inventors have also attempted to develop a laboratory test to measure the ability of water to remove concentrated or compacted soil from the coating without the use of mechanical action or force, but they have learned that in spite of a diligent effort and best practices for test method development, laboratory tests for the complex effects of water on soiling cannot capture the complexity of the real world and the test results are not well correlated with outdoor soiling performance. However, a functional test may be performed outdoors with exposure to real-world soiling and the inventors have developed a quantitative method for measuring outdoor soiling, which is described below as the “Outdoor Test.” Generally, articles coated with coatings of the present disclosure perform better than uncoated glass or glass coated with comparative formulations in at least one test, either the Dry Dust Test or the Outdoor Test during at least some of the time period of the outdoor exposure. Preferably, coatings of the present disclosure perform better than uncoated glass or glass coated with comparative formulations in the Outdoor Test at least some of the time during the period of the outdoor exposure.

One exemplary coating composition includes between about 0.25% to about 5% by weight of non-oxidizing nanoparticles having an average diameter of 20 to 120 nm, optionally from about 0.25% to about 5% by weight of non-oxidizing nanoparticles having average diameter of less than 20 nm, from about 0.1% to 5% by weight of a polymer wherein at least 90% of the monomer units comprise at least one carboxylate group or the conjugate acid thereof, optionally from about 0.1% to 5% of a metallic cation with a positive charge of at least +2, and optionally a non-polymeric acid in amount to produce a liquid of from about pH 7.0 to pH 2.5. Preferably the coating composition is an aqueous composition. The aqueous continuous liquid phase may be essentially free of organic solvents, except for very small amounts as may unavoidably be present as impurities in water supplies used to prepare the coating compositions (typically less than 0.1% and preferably less than 0.01%).

In some embodiments, the nanoparticles are nominally spherical. The nanoparticles may agglomerate into larger, non-spherical shapes, but substantial agglomeration is not preferred.

Exemplary commercially available silica nanoparticles for use in the coatings described herein include, for example, nonporous spherical silica nanoparticles in aqueous media (sols). For example, products under the trade designations LUDOX from WR Grace and Company of Columbia, Md., NYACOL from Nyacol Co. of Ashland, Mass., or NALCO from Nalco Chemical Co. of Naperville, Ill. One silica sol that is useful as a small nanoparticle, with a volume average particle size of 5 nm and a nominal solids content of 15 percent by weight, is available as NALCO 2326 from Nalco Chemical Co. Other useful commercially available silica sols include those available as NALCO 1115 (4 nm) and NALCO 1130 (8-9 nm) from Nalco Chemical Co., as REMASOL SP30 (8-9 nm) from Remet Corp. of Utica, N.Y., and as LUDOX SM (7 nm) from WR Grace. One silica sol that is useful as a large nanoparticle, with a volume average particle size of 45 nm and a nominal solids content of 40%, is available as NALCO DVSZN004 from Nalco Chemical Co. Other useful commercially available silica sols include those available as NALCO 2329 (75 nm) from Nalco Chemical Co. and LUDOX™ (22 nm) available from WR Grace.

Coating compositions according to the present disclosure may be made by any suitable mixing technique. One useful technique includes combining alkaline spherical silica sols of appropriate particle size with water, optionally adding non-polymeric acid to adjust the pH to a desired level and then mixing with a solution of the polymer wherein at least about 90% of the monomer units comprise at least one carboxylate group or the conjugate acid thereof, and then optionally adding a metallic cation with a positive charge of at least +2. Preferably, the polymer is dissolved in water. Another useful technique includes combining alkaline spherical silica sols of appropriate particle size with water, then adding optional metallic cation, then adding a solution of the polymer dissolved in water. It may be useful to separately premix some components in one container and other components in another container, and to mix them immediately prior to use. It may be useful to mix some or all components from 1 to 60 hours prior to use.

Some coating methods of the present disclosure involve applying the liquid coating composition to the substrate, optionally for a period of time. The coating liquid may be applied by methods such as, for example, rolling, flooding, spraying, dip coating or submersion. The amount of time that may optionally be used may be in the range of 10 to 300 seconds. During this time, some of the nanoparticles may react with the substrate. As applied to the substrate, the coating liquid may be 0.25 micron to 4 microns in thickness. Coating equipment and processes as are known to those skilled in the art, for example, roll coaters with solid or gravure rolls or dip coating, may be used to produce a suitable wet coating thickness. Optionally, the coating liquid as applied to the substrate may be thicker than 4 microns and the coating method may include an additional step wherein the thickness of the wet coating is reduced to between about 0.25 micron to 4 microns in thickness before drying. In some embodiments, the wet coating thickness is between about 0.5 and about 3 microns in thickness. Preferably, the wet coating thickness is in the range of 0.25 to 4 micrometers, more preferably 0.5 to 3 micrometers in the final step before evaporation of the water in the coating composition to form a dried coating. Evaporation may be accomplished by allowing the substrate to dry under ambient conditions, that is, to air dry. In other embodiments, the drying is accomplished by artificially providing heat to the coating. In some embodiments, substantially all of the water in the coating composition is evaporated, for example, at least 95% of the water is evaporated, preferably 98% of the water. Those skilled in the art will recognize that many materials, including glass, silica and the coatings of this invention, may retain traces of water, particularly on their surfaces, depending on ambient conditions, unless they are subjected to combinations of high temperatures (such as over 100° C. or even over 200° C.) and very low pressure (such as 0.1 standard atmosphere or even 0.01 standard atmosphere). After evaporation, a dried coating is formed. In certain embodiments, the dried coating has an average surface roughness of between about 3 nm and about 100 nm over a 5 microns by 5 microns area, in other embodiments an average surface roughness of from 5 to 100 nm over a 5 micron by 5 micron area. In certain embodiments, the dried coating has an average thickness of about 2 nm to about 75 nm.

When the coating composition contains nanopaticles of two or more sizes, with some nanoparticles whose diameter is less than 20 nm (e.g., “small” nanoparticles) and some nanoparticles whose diameter is 20 nm or greater (e.g., “large” nanoparticles), a dry coating may have an average thickness over an area of 5 micron by 5 micron, for example, 25 nm average thickness, but over a smaller area (such as 40 nm×40 nm), there may be a large particle protruding from the coating for a thickness of 50 nm, and over another smaller area 40 nm×40 nm there may be only about several layers of small nanoparticles for a thickness of about 15 nm. Thus the surface of the dry coating may be rough on the scale of nanometers and such roughness may be detected by atomic force microscopy (AFM). For example, surface roughness analyses may be performed using a Dimension™ 3100 Atomic Force Microscope (available from Veeco Metrology Group. Tucson Ariz.) in tapping mode. Typical analysis conditions may be as follows: The probes may be 1 ohm silicon probes (OTESPA) with spring constants between 20 and 80 Newton/meter and resonance frequency approximately 310 kHz. Imaging parameters may be about 68 to 780% of the set point, and the driving amplitude may be about 40 to 60 mV. Gains may be 04 to 0.6 for integral gain and 0.5 to 0.7 for proportional gain. Scan rate may be about 1 Hz for 5 micron×5 micron area, and 512×512 data points may be collected. Data processing for topography may use 1^{st} order XY plane fitting and zero order flattening and data processing for phase may use zero order flattening. R_{q} (Root-Mean-Square) roughness and average roughness for the 5 micron×5 micron area may be calculated from the data that are obtained. It may also be possible to measure these various thicknesses and roughnesses by examining a cross-section of coating by, for example, scanning electron microscopy. For another example, if at least some of the substrate is exposed and can be detected by AFM as the base material/position, then AFM can also be used to measure coating thickness. As used herein, the term “average coating thickness” refers to the coating thickness over an area that is at least 20 times larger than the largest nanoparticle in the liquid coating composition, for example, for a liquid coating composition containing nanoparticles of diameters 4 nm and 42 nm, the average coating weight refers to the coating weight over an area of at least 0.84 micron×0.84 micron.

The wet coating thickness is selected, in combination with the concentration of nanoparticles in the coating composition, to produce a dry coating (after evaporation) that has an average thickness of from about 0.5 nm to about 100 nm, more preferably about 2 nm to about 75 nm average thickness, even more preferably from about 5 nm to about 50 nm average thickness. The first step of the coating process may produce a wet coating thickness of 0.25 micron to 4 microns, or it may produce a wet coating thickness of greater than 4 microns. A second step may be needed to reduce the wet coating thickness, and one method for the second step is to draw a flexible blade across the wet glass surface. For example, a hand-held flexible blade may be used. Flexible blades may be made of any rubbery material, such as natural rubber or polymers such as plasticized poly(vinylchloride), silicone polymers, polyurethanes, polyolefins, fluoropolymers, and the like. Flexible blades are often referred to as “squeegees.” Details of suitable coating methods have been described by the inventors in PCT Application No. PCT/US2013/049300, whose description of experimental methodology is incorporated by reference herein. Preferably, the wet coating thickness is reduced by the use of a flexible blade, and it may be preferable to avoid the use of additional water, for example, rinsing, for at least a period of time following the application of the coating liquid to the substrate.

In preferred embodiments, the dry coating is durable. In this context, “durable” means that the dry coating provides antisoiling performance after two wash cycles or two rain falls, wherein the wash cycles or rain falls are sufficient to remove at least some dirt from the surface of the coated article.

Objects and advantages of this disclosure are further illustrated by the following non-limiting examples, but the particular materials and amounts thereof recited in these examples, as well as other conditions and details, should not be construed to unduly limit this disclosure.

### Examples

### Materials:

### Nanoparticles

Spherical silica nanoparticle dispersions used are commercially available from the Nalco Company, an Ecolab Company, Naperville, Ill. under the trade designations: “NALCO 1115” (4 nm particles, supplied as about 16% by weight in water) and “NALCO DVSZN004” (42 nm particles, supplied as about 41% by weight in water).

### Polymers

Polymers used to prepare the liquid coating compositions of this invention were prepared as follows:

The monomers as indicated in Table 1 were placed In a clean glass reaction bottle with the chain transfer agent, initiator, and IPA or water. The mixture was purged with nitrogen for 3 minutes. The reaction bottle was sealed and placed in a preheated water bath with agitation. The reaction mixture was heated for 17 hours at 50° C. when V-50 initiator was used and at 65° C. when Vazo-67 was used. The viscous reaction mixture was analyzed by % solids analysis. To convert the residual monomer to >99.5%, another 0.1 parts of initiator was added, the solution was purged and sealed, placed in the hot water bath at same reaction temperature with agitation and heated for an additional 8 hours. A high conversion of (>99.5%) was achieved as shown by % solids analysis. Polymers 4 through 8 were neutralized with 10% LiOH to a pH of 6 to 7.

All materials used to prepare the polymers are available from Sigma-Aldrich Company (St. Louis, Mo.). AA is acrylic acid, MEA is methoxyethyl acrylate, HEMA is 2-hydroxyethyl methacrylate, NIPPAM is N-isopropylacrylamide, ITA is itaconic acid, b-CEA is beta-carboxyethylacrylate, CBr₄ is carbon tetrabromide,

t-DDM is tert-dodedylthiol, V-50 is 2,2′-Azobis(2-methylpropionamidine) dihydrochloride, Vaso-67 is 2,2′-azodi(2-methylbutyronitrile) and IPA is isopropyl alcohol. Since many of these materials are known by alternative chemical names, the CAS Number is also shown in Table 1. The inventors used materials supplied by Sigma-Aldrich, except for V-50, which was obtained from Wako Chemicals USA, Inc. (Richmond, Va.) and Vazo-67, which was obtained from E.I. du Pont de Nemours and Company (Wilmington Del.).

TABLE 1

| Material | AA | MEA | HEMA | NIPPAM | ITA | b-CEA | CBr4 | t-DDM | V-50 | Vazo-67 | IPA | Water | % solids |
|---|---|---|---|---|---|---|---|---|---|---|---|---|---|
| CAS # | 79- | 3121- | 868- | 2210- | 97- | 24615- | 558- | 25103- | 2997- | 13472- | | | |
| | 10-9 | 61-7 | 77-9 | 25-5 | 65-4 | 84-7 | 13-4 | 58-6 | 92-4 | 08-7 | | | |
| Polymer 1 | 90 | 10 | 0 | 0 | 0 | 0 | 0 | 0 | 0 | 0.5 | 400 | 0 | 21.6 |
| Polymer 2 | 90 | 10 | 0 | 0 | 0 | 0 | 0.5 | | 0.5 | 0 | 0 | 400 | 20.3 |
| Polymer 3 | 90 | 10 | 0 | 0 | 0 | 0 | 0 | 0.5 | 0 | 0.5 | 300 | 0 | 28.9 |
| Polymer 4 | 100 | 0 | 0 | 0 | 0 | 0 | 0.5 | 0 | 0.5 | 0 | 0 | 400 | 18.7 |
| Polymer 5 | 0 | 0 | 0 | 0 | 100 | 0 | 0.5 | 0 | 0.5 | 0 | 0 | 400 | 16.3 |
| Polymer 6 | 80 | 0 | 0 | 0 | 0 | 20 | 0.5 | 0 | 0.5 | 0 | 0 | 400 | 17.4 |
| Polymer 7 | 80 | 0 | 0 | 0 | 20 | 0 | 0.5 | 0 | 0.5 | 0 | 0 | 400 | 17.6 |
| Polymer 8 | 0 | 0 | 0 | 0 | 50 | 50 | 0.5 | 0 | 0.5 | 0 | 0 | 400 | 18.2 |
| Polymer 9 | 80 | 10 | 0 | 10 | 0 | 0 | 0 | 0.5 | 0 | 0.5 | 300 | 0 | 28.8 |

Additionally, the following polymers were obtained from Sigma-Aldrich Corporation (St. Louis, Mo.): Polymer 10 was poly(acrylic acid, sodium salt), M_{w} 1200, 45% by weight in water,

Polymer 11 was poly(acrylic acid, sodium salt), M_{w} 5100, 100% solids, and

Polymer 12 was poly(acrylic acid, sodium salt), M_{w} 15,000, 35% by weight in water.

### Other Additives

Nitric acid was 67-70% Nitric acid, supplied by VWR International (VWR International, West Chester Pa.). It was diluted to 10% nitric acid by mixing water (900 g) and 67-70% nitric acid (154 g). NaOH, zinc(II) acetate dihydrate, and copper(II) acetate hydrate were supplied as solid materials by Sigma-Aldrich and were dissolved in water to make a solution that was 10% by weight of each material as supplied. Phosphoric acid, 85% was supplied by VWR. It was diluted to 10% phosphoric acid by mixing water (90 g) and 85% phosphoric acid (12 g).

All water used in these examples was either deionized water or distilled water, except as indicated.

### Substrates

Glass mirrors were used as substrates for coating and for control experiments, unless otherwise indicated, and were Guardian standard mirror, 3.2 mm thick (Guardian Industries, Auburn Hills Mich.).

Unless otherwise indicated, glass mirror substrates were cleaned by gently scrubbing with a solution of Liquinox detergent (Alconox, Inc. White Plains N.Y.) and a paper towel, followed by thorough rinsing with either running tap water or running deionized or distilled water, followed by a final rinse with deionized or distilled water, then air-drying, prior to use.

For some samples, as indicated, a polymeric mirror film was used as a reflective material (3M Solar Mirror Film2020, 3M Company, St. Paul, Minn.). This mirror film was laminated to a rigid sheet of aluminum of thickness 0.89 mm using 3M Optically Clear Adhesive 8172 prior to cutting to size (about 10×15 cm) and coating.

### Coating Method

Pieces of glass mirror were cut to a size of about 10×15 cm. Samples were coated by submerging a portion or all of the piece of glass into a polyethylene container containing the coating liquid, and waiting for 30 seconds. The sample was withdrawn from the coating liquid over a period of 1-3 seconds and then a squeegee with a rubber blade was immediately (within 2-4 seconds) used to remove all but a very thin amount of coating liquid from the reflective side of the mirror. The samples were then allowed to air dry under ambient conditions. Alternatively, the mirror was placed in a horizontal position with the reflective side up, coating liquid was applied in excess using a pipette to produce a thick liquid layer and allowed to remain there for 30 seconds. Then excess coating liquid was removed with a squeegee and the samples were allowed to air dry. These coating methods were used interchangeably, as the coating that resulted was the same with either method.

To avoid confusion, all coating liquids, both Comparative Examples and Examples, were given a number from 1 to 99. Coated substrates were given numbers from 101 to 400, corresponding to the coating liquid used to prepare them. Thus, Comparative Example 1 (Liquid) was coated onto a glass mirror as above, to produce Comparative Example 101 (Coated Mirror). In some cases, multiple pieces of glass mirror were coated with the same liquid and then used in different tests, for example, one piece of Comparative Example 101 (Coated Mirror) was used in a laboratory test and another piece of Comparative Example 101 (Coated Mirror) was used in an outdoor test. The same number is used to refer to all pieces of glass mirror coated with the same coating liquid, but a different, fresh piece was used in each experiment. The only exception to this in the Dry Dust Test (Round 2), described below, where the same piece of glass mirror was used in both the first and second challenge with dry dust.

Uncoated glass mirrors were also tested and given the number Comparative Example 100. Uncoated polymeric mirror film was also tested and given the number Comparative Example 200 and a polymeric mirror film coated with coating liquid Example 5 was given the number Example 205.

### Test Methods:

### Gloss

Gloss measurements were performed with a BYK micro-Tri-Gloss Meter, Cat. No. AG-4448 (BYK-Gardner USA, Columbia Md.) which measures gloss at angles of 20, 60 and 85 degrees. Unless otherwise noted, 3 measurements were made at 3 different positions at an angle of 20 degrees on each sample, and the average of the 3 measurements is reported. In those cases where there were multiple replicates (that is, multiple samples that were made in an identical manner using the same coating liquid formulation), the results for all replicates were averaged and are reported in the Tables.

### Dry Dust Test

Pieces of substrate mirror were cut to a size of about 10×15 cm and coated as indicated. Samples (uncoated, partially coated or fully coated substrates, as indicated) were placed in racks that allowed good air circulation around the entire sample, and then placed in a controlled humidity room at 15% relative humidity at about 21° C. The samples were allowed to equilibrate with the surroundings for at least 6 hr. Arizona Test Dust Fraction, Nominal 0-70 micron (Powder Technology, Inc., Burnsville, Minn.) was placed in shallow pans in the controlled humidity room and allowed to equilibrate with the surroundings for at least 6 hr.

Still in the controlled atmosphere, samples were placed, coating-side up, in a flat horizontal position. Gloss was measured at an angle of 20 degrees. A laboratory stainless steel “reagent digger” spatula, approximately length 9 inch and width of open edge about 1 cm (available from Cole-Parmer, Vernon Hills Ill. as Product #WU-01019-13) was over-filled with the Arizona Test Dust, leveled off using a spatula, then carefully inverted onto the 15 cm edge of a sample. About 6-7 g of Arizona Test Dust was thus deposited on the edge of the sample, in a pile about 1 cm wide at the base. The sample was then lifted from the edges with the dust pile at the top, and tilted to about a 45 degree angle to allow the dust to slide across and off the sample. The sample was then positioned vertically and tapped twice to remove any large clumps of dust that were not adhered. Once again, gloss was measured at 20 degrees. Typically, the gloss measurement after application of the dust was lower than the original, clean measurement, because any dust that was present would scatter and/or absorb some of the incident light. The dust was loosely adhered, and the base of the gloss meter could dislodge some dust or leave a visible “footprint,” so multiple measurements were made only if the sample was large enough to permit multiple measurements of undisturbed areas.

Using single measurements or averages of multiple measurements on the same sample, “% Retention” was calculated according to the formula:

% Retention=(Final Gloss Measurement×100)/Initial Gloss Measurement

As the amount of dust on a sample increases, the gloss measurement and % retention decreases. The dust was discarded after use with one sample, and fresh dust was used for each sample tested.

### Dry Dust Test (Round 2)

In some cases, after the Dry Dust Test above, the soiled samples were rinsed with water but not scrubbed, to observe whether the soil that had accumulated could be removed without scrubbing. Typically, rinsing for about 10 seconds under a gentle stream of laboratory distilled water (about 240 to 260 gm of water) was sufficient to remove the dust, as judged by visual examination. Samples that had large amounts of dust on them were typically not completely clean after such rinsing, but additional rinsing usually did not remove additional dust in these cases, and the same rinsing methods were used for all samples. The samples were allowed to air dry, and gloss was measured again as a quantitative means of determining how much dust remained. Then, these samples were subjected to a second round of the Dry Dust Test, (starting with placement in a 15% RH environment, etc. as described above) to see if they resisted the accumulation of dry dust as well in the second round, after rinsing, as they had in the first round.

### Outdoor Test

Pieces of substrate mirror to were cut to a size of about 10×15 cm and coated as indicated. Samples (uncoated or fully coated substrates, as indicated), with three replicated (that is, 3 pieces of mirror with identical coatings) were attached to aluminum panels (typically about 30×120 cm) using double-sided foam tape across the entire back of the mirror, positioned in a single horizontal row so that the 15 cm side of each mirror was vertical and spaced with at least about 2.5 cm between mirror samples. The gloss of each piece of mirror was measured at a 20-degree measurement angle in three mirror positions (initial). The aluminum panels were then affixed to metal racks in a test facility in Phoenix, Ariz., USA at an angle of 34 degrees from horizontal, and allowed to accumulate soil in the outdoor environment. After one week of exposure, 20-degree gloss was measured in 3 positions on each sample, and subsequent measurements of 20-degree gloss were made at one week intervals. Samples were not cleaned before or after these measurements, and they were not protected from rain, wind, sun, temperature changes or other elements of the weather. The amount of soiling that occurred during any period of time could be different that the amount of soiling that occurred during a different period of time, but for any set of samples and controls exposed during the same time period, the amount of soiling was the same and it was possible to make direct comparisons between samples. The dates when samples were placed outdoors were recorded.

Using the average of nine measurements (three measurements on the each piece of mirror and three pieces of mirror for each coating formulation), “% Retention” was calculated each week according to the formula:

Retention=(Average Gloss Measurement×100)/(Average Initial Gloss Measurement)

Higher % Retention means that less soil has accumulated.

### Preparation of Coating Liquids

Coating liquids were prepared by charging a plastic (polyethylene, polypropylene or polystyrene) container with the materials in Table 2 in the order shown from left to right, with mixing after each addition. That is, the First Material was placed in the container in the amount shown in grams, the Second Material in the next column was added in the amount shown in grams and mixed, then the Third Material (if any) was added and mixed, and so on, for as many columns and materials as are indicated. For the first entry Table 2, Comparative Example 1, a more detailed description is provided below. Unless indicated, there is no known effect of mixing order. However, the inventors avoided adding solid or very concentrated materials to anything other than water, to reduce the possibility of undesirable reactions occurring from high local concentrations before mixing was complete. In some cases, a liquid was prepared and used both for coating and testing and also to prepare other liquids. In some cases, multiple batches of a liquid were prepared as needed but only one batch is shown in Table 2. In some cases, the pH of the liquid was measured using pH test strips when all materials had been mixed; such measurements were accurate to within about one pH unit.

Silica nanoparticles were received from the supplier as a dispersion in water and were used as received. All other materials were either received as solid and dissolved in water to the solids indicated, or received as a solution and further diluted to the % solids indicated.

Comparative Example (CE) 1 (Liquid) was prepared by placing 1554 g water in a polyethylene container, then adding 164.1 g NALCO 1115 and mixing. Then 25.54 g NALCO DVSZN004 was added with mixing and then 20.81 g 10% nitric acid was added and mixed. Additional nitric acid, about 6.47 g, was added in small portions until pH 2.75 was reached, as measured with a calibrated pH meter. The total amount of nitric acid used was about 27.28 g; the exact amount needed to reach pH 2.75 varied slightly as different lots of NALCO materials were used. CE 1 (Liquid) was used to coat some substrates and the liquid was also mixed with additional materials to prepare some Comparative Examples and some Examples.

In Tables, CE is used as an abbreviation for Comparative Example and EX is used as an abbreviation for Example

TABLE 2
Coating Liquids

| | First Material | | Second Material | | Third Material | | Fourth Material | | |
|---|---|---|---|---|---|---|---|---|---|
| Liquid # | Material | g | Material | g | Material | g | Material | g | pH |
| CE 1 | Water | 1554 | Nalco 1115 | 164.1 | Nalco | 25.54 | Nitric acid, | 27.28 | 2.75 |
| | | | | | DVSZN004 | | 10% | | |
| CE 2 | Water | 155.0 | Nalco 1115 | 16.4 | Nalco | 2.55 | | | |
| | | | | | DVSZN004 | | | | |
| CE 3 | Water | 50.0 | Polymer 1 | 5.2 | | | | | 3 |
| CE 4 | Water | 50.0 | Polymer 2 | 5.5 | | | | | |
| CE 5 | Water | 50.0 | Polymer 3 | 3.8 | | | | | |
| CE 6 | Water | 50.0 | Polymer 4 | 6.0 | | | | | 6 |
| CE 7 | Water | 87.7 | Polymer 5 | 12.3 | | | | | 6 |
| CE 8 | Water | 50.0 | Polymer 6 | 6.5 | | | | | 6 |
| CE 9 | Water | 50.0 | Polymer 7 | 6.5 | | | | | 6 |
| CE 10 | Water | 50.0 | Polymer 8 | 6.2 | | | | | 8 |
| CE 11 | Water | 50.0 | Polymer 10 | 2.4 | | | | | 9 |
| CE 12 | Water | 50.0 | Polymer 11 | 1.0 | | | | | 9 |
| CE 13 | Water | 50.0 | Polymer 12 | 3.1 | | | | | |
| CE 14 | Water | 50.0 | Polymer 9 | 3.80 | | | | | |
| CE 15 | CE 11 | 4.54 | Nitric acid, | 0.51 | | | | | 3 |
| | | | 10% | | | | | | |
| CE 16 | CE 6 | 4.80 | NaOH, 10% | 0.22 | | | | | 14 |
| CE 17 | CE 12 | 11.37 | Nitric acid, | 0.75 | | | | | 5 |
| | | | 10% | | | | | | |
| CE 18 | CE 7 | 3.47 | Nitric acid, | 0.35 | | | | | 3 |
| | | | 10% | | | | | | |
| CE 19 | CE 9 | 4.10 | NaOH, 10% | 0.52 | | | | | 14 |
| CE 20 | CE 1 | 8.00 | CE 3 | 8.00 | | | | | |
| CE 21 | CE 3 | 4.24 | NaOH, 10% | 0.74 | | | | | 14 |
| CE 22 | CE 1 | 8.00 | CE 14 | 8.00 | | | | | |
| CE 23 | Water | 219.7 | Nalco 1115 | 23.6 | Nalco | 3.77 | Phosphoric | 8.26 | |
| | | | | | DVSZN004 | | acid, 10% | | |
| EX 1 | CE 1 | 8.28 | CE 12 | 8.28 | | | | | 9 |
| EX 2 | CE 1 | 8.00 | CE 10 | 8.00 | | | | | 7 |
| EX 3 | CE 1 | 8.00 | CE 11 | 8.00 | | | | | 7 |
| EX 4 | CE 1 | 8.00 | CE 8 | 8.00 | | | | | 6 |
| EX 5 | CE 1 | 8.00 | CE 9 | 8.00 | | | | | 6 |
| EX 6 | CE 1 | 8.00 | CE 7 | 8.00 | | | | | 6 |
| EX 7 | CE 1 | 8.00 | CE 6 | 8.00 | | | | | 6 |
| EX 8 | CE 7 | 6.75 | Nalco | 0.36 | Nitric acid, | 0.81 | | | 1 |
| | | | DVSZN004 | | 10% | | | | |
| EX 9 | CE 1 | 10.30 | Water | 10.10 | CE 9 | 2.31 | | | |
| EX 10 | CE7 | 9.52 | Nalco | 1.90 | Nitric acid, | 0.33 | zinc (II) | 0.88 | |
| | | | DVSZN004 | | 10% | | acetate) | | |
| | | | | | | | dihydrate, 10% | | |
| EX 11 | CE 7 | 20.00 | Nalco | 1.08 | Nitric acid, | 2.42 | zinc (II) | 1.75 | |
| | | | DVSZN004 | | 10% | | acetate) | | |
| | | | | | | | dihydrate, 10% | | |
| EX 12 | CE 11 | 20.00 | Nalco | 1.09 | zinc (II) | 1.44 | Nitric acid, | 2.31 | |
| | | | DVSZN004 | | acetate) | | 10% | | |
| | | | | | dihydrate, 10% | | | | |
| EX 13 | CE 23 | 10.00 | CE 6 | 9.98 | | | | | |
| EX 14 | Water | 10.0 | Nalco | 0.52 | CE 6 | 10.43 | copper (II) | 1.62 | |
| | | | DVSZN004 | | | | acetate | | |
| | | | | | | | hydrate, 10% | | |
| EX 15 | CE 6 | 20.1 | Nalco | 1.02 | Nitric acid, | 2.42 | zinc (II) | 1.75 | |
| | | | DVSZN004 | | 10% | | acetate) | | |
| | | | | | | | dihydrate, 10% | | |

EX 10 was prepared and stored for 5 days before coating. EX 11 was prepared and coated on the same day.

### Dry Dust Test Results

The laboratory Dry Dust Test was performed on coated mirrors, using as coating liquids both Comparative Examples and Examples. The results are shown in Table 3.

TABLE 3
Dry Dust Test Results

| | 20 Degree Gloss | | |
|---|---|---|---|
| Sample # | Before | After | % Retention |
| CE 103 | 1826 | 411 | 23 |
| CE 114 | 1831 | 449 | 25 |
| CE 114 | 1820 | 541 | 30 |
| CE 112 | 1830 | 666 | 36 |
| CE 115 | 1829 | 688 | 38 |
| CE 116 | 1815 | 724 | 40 |
| CE 110 | 1833 | 764 | 42 |
| CE 117 | 1832 | 777 | 42 |
| CE 107 | 1826 | 848 | 46 |
| CE 111 | 1810 | 858 | 47 |
| CE 108 | 1832 | 880 | 48 |
| CE 118 | 1824 | 949 | 52 |
| CE 119 | 1811 | 1167 | 64 |
| CE 106 | 1833 | 1271 | 69 |
| CE 109 | 1823 | 1355 | 74 |
| CE 122 | 1823 | 434 | 24 |
| CE 120 | 1823 | 657 | 36 |
| EX 101 | 1834 | 732 | 40 |
| EX 102 | 1831 | 741 | 40 |
| EX 103 | 1829 | 1037 | 57 |
| EX 104 | 1819 | 1581 | 87 |
| EX 105 | 1824 | 1588 | 87 |
| EX 106 | 1823 | 1610 | 88 |
| EX 107 | 1823 | 1695 | 93 |
| EX 108 | 1814 | 1692 | 93 |

### Table 4. Outdoors Test Results

Samples were placed outdoors in Phoenix Ariz. As was typical and was expected, outdoor soiling did not occur in a “linear” manner; instead, some soil accumulated in varying amounts from week to week and then weather events caused some removal of soil/cleaning between Weeks 6 and 7. Initial gloss and gloss for 7 weeks of outdoor exposure was measured and is presented in Table 4. Initial gloss and % Retention of Initial Gloss after each week of exposure was measured. The data in Table 4 are the averages of 3 measurements on each piece of mirror for 3 replicates, that is, the average of 9 data points for each week.

To make it easier to compare the data for multiple weeks, the difference between the Examples and Comparative Example 102 for Weeks 3-6 was calculated by summing the “% of original gloss” for each Example for those 4 weeks and then subtracting the “% of original gloss” for Comparative Example 102 for the same 4 weeks. The results are shown in the last column.

TABLE 4
Outdoor Test Results

| | Sample | Initial | | | | | | | | |
|---|---|---|---|---|---|---|---|---|---|---|
| Wave | # in | G20 | | | | | | | | Comparison, |
| 2.4# | Patent | Gloss | Wk 1 | Wk 2 | Wk 3 | Wk 4 | Wk 5 | Wk 6 | Wk 7 | Wks 3-6 |
| 496 | EX 107 | 1817 | 96 | 95 | 94 | 94 | 93 | 91 | 96 | 21 |
| 517 | EX 106 | 1831 | 99 | 95 | 95 | 94 | 93 | 89 | 95 | 20 |
| 541 | EX 102 | 1828 | 98 | 94 | 95 | 93 | 92 | 89 | 95 | 18 |
| 550 | EX 105 | 1825 | 96 | 94 | 93 | 93 | 92 | 90 | 95 | 17 |
| 553 | EX 109 | 1833 | 97 | 94 | 94 | 93 | 91 | 89 | 95 | 16 |
| 523 | EX 110 | 1808 | 97 | 94 | 93 | 93 | 92 | 88 | 94 | 15 |
| 424 | EX 111 | 1822 | 95 | 94 | 92 | 92 | 91 | 90 | 96 | 14 |
| 418 | EX 112 | 1830 | 96 | 94 | 93 | 93 | 91 | 88 | 96 | 14 |
| 520 | EX 108 | 1813 | 97 | 93 | 93 | 92 | 90 | 89 | 95 | 13 |
| 532 | EX 112 | 1775 | 96 | 94 | 92 | 92 | 90 | 89 | 96 | 12 |
| 409 | EX 105 | 1825 | 96 | 92 | 92 | 90 | 89 | 83 | 93 | 3 |
| 526 | CE 111 | 1754 | 98 | 95 | 93 | 93 | 92 | 86 | 93 | 13 |
| 421 | CE 106 | 1822 | 95 | 91 | 91 | 91 | 89 | 87 | 94 | 7 |
| 511 | CE 107 | 1807 | 98 | 95 | 92 | 91 | 90 | 84 | 95 | 6 |
| 502 | CE 105 | 1819 | 95 | 92 | 91 | 90 | 89 | 86 | 93 | 5 |
| 451 | CE 102 | 1825 | 94 | 90 | 88 | 89 | 88 | 86 | 95 | 0 |
| 508 | CE 105 | 1820 | 94 | 90 | 89 | 89 | 88 | 85 | 94 | 0 |
| 535 | CE 108 | 1828 | 95 | 91 | 86 | 87 | 87 | 81 | 90 | −10 |

The liquids in Examples 5, 7, 11 and 12 were also coated onto the front surface of photovoltaic modules, where the front surface glass had a slight texture (so-called “rolled” glass is frequently used as the sun-facing surface in photovoltaic modules to reduce the reflective, shiny appearance that many consumers find unattractive). It is not possible to make accurate gloss measurements on photovoltaic modules made with rolled glass, but the modules were examined visually for multiple weeks of exposure in Phoenix, Ariz. After 90 days, four different people observed that the modules coated with Examples 5, 7, 11 and 12 appeared to be cleaner than Comparative Examples that had no coating on them or that were coated with CE 1.

TABLE 5
Dry Dust Data, before and after rinsing

| | Dry Dust Test (Round 1) | | | Dry Dust Test (Round 2) | | |
|---|---|---|---|---|---|---|
| Sample | 20 degree gloss | | % | 20 degree gloss | | % |
| # | Initial | After Dust | Retention | Initial | After Dust | Retention |
| CE 100 | 1827 | 847 | 46 | 1818 | 1390 | 76 |
| CE 101 | 1829 | 1814 | 99 | 1824 | 1819 | 100 |
| EX 107 | 1829 | 1764 | 96 | 1786 | 1727 | 97 |
| EX 113 | 1826 | 1756 | 96 | 1803 | 1765 | 98 |
| EX 114 | 1820 | 1746 | 96 | 1802 | 1697 | 94 |
| EX 112 | 1829 | 1570 | 86 | 1824 | 1799 | 99 |
| EX 115 | 1831 | 1542 | 84 | 1810 | 1803 | 100 |
| EX 105 | 1836 | 1086 | 59 | 1817 | 1414 | 78 |
| EX 205 | 1988 | 1885 | 95 | 1977 | 1888 | 95 |
| CE 200 | 1980 | 846 | 43 | 1845 | 511 | 28 |

Comparative Examples 112, 113 and 114 (coated mirrors) showed % Retention after Round 1 of the Dry Dust Test of 49, 47 and 30%, respectively. All of them looked dirty and were rinsed as described above. All of them appeared to be cleaner after rinsing but also showed a hydrophobic surface that is characteristic of bare glass, indicating removal of the comparative coating during rinsing.

1. A coated article comprising a dry coating, wherein the dry coating comprises:
a first set of non-oxidizing nanoparticles having an average diameter of 20 nm to 120 nm;
an optional second set of non-oxidizing nanoparticles having an average diameter of less than 20 nm;
a polymer comprising monomer units;
wherein at least 90% of the monomer units comprise at least one carboxylate group or the conjugate acid thereof;
wherein the dry coating is hydrophilic;
wherein the dry coating is on the surface of the coated article;
optionally one or more metallic cations with a positive charge of at least +2; and
an optional non-polymeric acid.

2. (canceled)

3. The coated article according to claim 1, wherein at least 95% of the polymer monomer units comprise at least one carboxylate group or a conjugate acid thereof.

4. The coated article according to claim 1, wherein the first set of nanoparticles has an average diameter of 20 nm to 75 nm.

5-6. (canceled)

7. The coated article according to claim 1, comprising the second set of nanoparticles, wherein the second set of nanoparticles has an average diameter of less than 15 nm.

8. (canceled)

9. The coated article according to claim 1, wherein the monomer unit in the polymer is chosen from one or more of acrylate, itaconate, beta-carboxyethyl acrylate and the corresponding conjugate acids thereof.

10. The coated article according to claim 1, comprising one or more metallic cations with a positive charge of at least +2; wherein the one or more metallic cations are chosen from cations of a metal in Groups 2 to 16 of the periodic table.

11-14. (canceled)

15. The coated article according to claim 1, wherein the average surface roughness of the dry coating is from 5 nm to 100 nm over a 5 micron by 5 micron area.

16-18. (canceled)

19. The coated article according to claim 1, wherein the dry coating has an average thickness from 2 to 75 nm.

20. An antisoiling coating composition comprising an aqueous composition comprising:
a first set of non-oxidizing nanoparticles having an average diameter of 20 nm to 120 nm;
an optional second set of non-oxidizing nanoparticles having an average diameter of less than 20 nm;
a polymer comprising monomer units;
wherein at least 90% of the monomer units comprise at least one carboxylate group or the conjugate acid thereof;
wherein the dry coating is hydrophilic;
wherein the dry coating is on the surface of the coated article;
an optional metallic cation with a positive charge of at least +2;
an optional non-polymeric acid.

21. (canceled)

22. The antisoiling coating composition according to claim 1, wherein at least 95% of the polymer monomer units comprise at least one carboxylate group or a conjugate acid thereof.

23-25. (canceled)

26. The antisoiling coating composition according to claim 20, comprising the second set of nanoparticles, wherein the second set of nanoparticles has an average diameter of less than 15 nm.

27. (canceled)

28. The antisoiling coating composition according to claim 20, wherein the monomer unit in the polymer is chosen from one or more of acrylate, itaconate, beta-carboxyethyl acrylate and the corresponding conjugate acids thereof.

29. The antisoiling coating composition according to claim 20, with a positive charge of at least +2; wherein the one or more metallic cations are chosen from cations of a metal in Groups 2 to 16 of the periodic table.

30-35. (canceled)

36. A method of forming a coating on a substrate, comprising:
applying an aqueous coating composition to the substrate;
wherein the aqueous coating composition comprises an aqueous dispersion comprising:
a first set of non-oxidizing nanoparticles having an average diameter of 20 nm to 120 nm;
an optional second set of non-oxidizing nanoparticles having an average diameter of less than 20 nm;
a polymer comprising monomer units;
wherein at least 90% of the monomer units comprise at least one carboxylate group or the conjugate acid thereof;
an optional metallic cation with a positive charge of at least +2;
an optional non-polymeric acid;
if necessary, reducing the thickness of the coating composition to about 0.25 to about 4 microns, and
evaporating at least some of the water;
wherein the dry coating is hydrophilic; and
wherein the dry coating is on the surface of the coated article.

37. (canceled)

38. The method according to claim 36, wherein at least 95% of the polymer monomer units comprise at least one carboxylate group or a conjugate acid thereof.

39-41. (canceled)

42. The method according to claim 36, comprising the second set of nanoparticles, wherein the second set of nanoparticles has an average diameter of less than 15 nm.

43. (canceled)

44. The method according to claim 36, wherein the monomer unit in the polymer is chosen from one or more of acrylate, itaconate, beta-carboxyethyl acrylate and the corresponding conjugate acids thereof.

45. The method according to claim 36, comprising one or more metallic cations with a positive charge of at least +2; wherein the one or more metallic cations are chosen from cations of a metal in Groups 2 to 16 of the periodic table.

46-49. (canceled)

50. The method according to claim 36, further comprising, if necessary, drying the coating, wherein the average surface roughness of the dried coating is from 5 nm to 100 nm over a 5 micron by 5 micron area.

51-53. (canceled)

54. The method according to claim 36, further comprising, if necessary, drying the coating, wherein the dried coating has an average thickness from 2 to 75 nm.
